(19) United States
(12) Patent Application Publication
(10) Pub. No.: US 2019/0252933 A1
(43) Pub. Date: Aug. 15, 2019

(54) VARIABLE FIELD MAGNET ROTATING ELECTRIC MACHINE

(71) Applicant: HONDA MOTOR CO., LTD., Tokyo (JP)

(72) Inventors: Manabu Yatsurugi, Wako-shi (JP); Yoshihisa Kubota, Wako-shi (JP)

(21) Appl. No.: 16/266,198

(22) Filed: Feb. 4, 2019

(30) Foreign Application Priority Data
Feb. 13, 2018 (JP) 2018-023563

(51) Int. Cl. H02K 1/27

(52) U.S. Cl. CPC H02K 1/276

(57) ABSTRACT

A variable field magnet rotating electric machine includes a stator, a rotor in which a rotary shaft is provided on a rotor core, and a movable iron core extending in an axial direction of the rotary shaft, wherein the movable iron core is configured to be capable of being inserted into the rotor core and to be movable in the axial direction.

### CROSS-REFERENCE TO RELATED APPLICATION

Priority is claimed on Japanese Patent Application No. 2018-023563, filed Feb. 13, 2018, the content of which is incorporated herein by reference.

### BACKGROUND OF THE INVENTION

### Field of the Invention

The present invention relates to a variable field magnet rotating electric machine.

### Description of Related Art

Among variable field magnet rotating electric machines, for example, one including a magnetic path formation unit (hereinafter referred to as a variable field mechanism) for further increasing the rotational speed in an IPM in which a permanent magnet is embedded in a rotor core is known. In the variable field mechanism, a movable iron core is provided in certain parts which are both ends of the rotor core with respect to a stacked thickness of the rotor core on which electromagnetic steel sheets are stacked. Also, in the rotor core, a central portion in the stacked thickness on which the electromagnetic steel sheets are stacked is connected to the rotary shaft.

According to this variable field magnet rotating electric machine, a magnetic path is formed by varying the movable iron core in a direction of approaching the rotor core in accordance with an increase in the number of revolutions of the rotor. Therefore, the magnetic flux generated from the permanent magnet of the rotor passes through the movable iron core. As a result, when the number of revolutions of the rotor increases, the magnetic flux acting on an outer side of the rotor in a radial direction (i.e., the field magnetic flux caused by the permanent magnet of the rotor) decreases. As a result, a generator component (induced voltage) decreases, and the number of revolutions of the rotor can be suitably increased (see, for example, Japanese Unexamined Patent Application, First Publication No. 2001-25190 (hereinafter referred to as Patent Document 1)).

### SUMMARY OF THE INVENTION

However, in the variable field magnet rotating electric machine described in Patent Document 1, the movable iron core is provided only in some parts that are both ends of the rotor core. For this reason, it is not possible to form a path in which the magnetic flux passes through only a part of the rotor core.

Also, since the movable iron core is provided in some parts that are both ends of the rotor core, only the center part of the rotor core is connected to the rotary shaft. That is, a connecting region in which the rotor core is connected to the rotary shaft is limited. Therefore, when the size of the rotor core (i.e., the rotor) increases, it is necessary to enlarge the connecting region which connects the central portion of the rotor core to the rotary shaft to ensure the connection strength.

Therefore, the region including the movable iron core is reduced such that it becomes small. For this reason, it is difficult to increase the size of the variable field magnet rotating electric machine, and there is room for improvement from this point of view.

An aspect according to the present invention has been made in view of the above circumstances, and an object thereof is to provide a variable field magnet rotating electric machine that can suitably increase the number of revolutions of a rotor and can also be applied when increasing a size thereof.

In order to solve the above problem and achieve the object, the present invention adopts the following aspects.

(1) A variable field magnet rotating electric machine according to an aspect of the present invention includes a stator, a rotor in which a rotary shaft is provided on a rotor core, and a movable iron core extending in an axial direction of the rotary shaft, wherein the movable iron core is configured to be capable of being inserted into the rotor core and to be movable in the axial direction.

According to the above aspect (1), the movable iron core is made to extend in the axial direction of the rotary shaft, and the movable iron core can be movably inserted into the rotor core. Therefore, the movable iron core can be disposed over the entire region of the stacked thickness of the rotor core. Using the movable iron core, a magnetic path can be formed over the entire region of the stacked thickness of the rotor core. As a result, the magnetic flux generated from the magnet of the rotor can be made to satisfactorily pass through the movable iron core, and the magnetic flux coupling with the stator on the outer side of the rotor in the radial direction (i.e., the field magnetic flux due to the magnet of the rotor) is reduced such that it becomes small. As a result, by changing the characteristics while reducing the torque or the induced voltage of the variable field magnet rotating electric machine such that it becomes small, the number of revolutions of the rotor can be increased.

Thus, in the low torque (low load) range, by controlling the movable iron core such that it is disposed in the rotor core, it is possible to drive the variable field magnet rotating electric machine while efficiently increasing the number of revolutions of the variable field magnet rotating electric machine.

On the other hand, when the movable iron core is moved from the rotor core, the empty space in the rotor core from which the movable iron core is extracted (removed) acts as a flux barrier. Since the space acts as a flux barrier, it is possible to prevent the magnetic flux generated from the magnet of rotor from passing through the space. Therefore, the magnetic flux that couples with the stator on the outer side of the rotor in the radial direction (i.e., the field magnetic flux due to the magnet of the rotor) increases. As a result, the torque density increases and the induced voltage increases.

Thus, by controlling the movable iron core such that it is removed from the rotor core in the high torque (high load) region, it is possible to drive the variable field magnet rotating electric machine, while efficiently suppressing the number of revolutions of the variable field magnet rotating electric machine.

In this way, the movable iron core is disposed in the rotor core in the low torque region, and the movable iron core is removed from the rotor core in the high torque region. Therefore, it is possible to control the amount of movement of the movable iron core, depending on the load acting on the variable field magnet rotating electric machine. This makes it possible to efficiently drive the variable field magnet rotating electric machine in the low torque region or the high torque region.

In addition, the movable iron core is movably inserted into the rotor core, and the movable iron core is disposed over the entire region of the stacked thickness of the rotor core. By disposing the movable iron core over the entire region of the stacked thickness of the rotor core, it is possible to form a path through which the magnetic flux passes over the entire region of the stacked thickness of the rotor core. Therefore, it is possible to satisfactorily reduce the torque or the induced voltage. Therefore, the variable field magnet rotating electric machine can be driven more efficiently.

Furthermore, the movable iron core is made to extend in the axial direction of the rotary shaft. Therefore, it is not necessary to directly attach the movable iron core to the rotary shaft. As a result, the entire region of the stacked thickness of the rotor core can be connected to the rotary shaft, and a large region of the rotor core which connects to the rotary shaft can be ensured. As a result, even when the size of the rotor core (i.e., the rotor) is increased, it is possible to ensure the connection strength of the connecting region which connects the rotor core to the rotary shaft, and it can be applied when the size of the variable field magnet rotating electric machine is increased. That is, the same structure can be adopted in the variable field magnet rotating electric machine, regardless of there being a small or large rotor.

(2) In the above aspect (1), the rotor may be an IPM in which a magnet is embedded in the rotor core.

According to the above aspect (2), by providing a magnet at the poles of the rotor, the rotor can be configured as an interior permanent magnet motor (IPM). An IPM refers to a configuration of a rotating field type in which a magnet (a permanent magnet) is embedded in a rotor core. By configuring a rotor as an IPM, the movable iron core can be disposed in the vicinity of the magnet. Therefore, it is possible to make the magnetic flux generated from the magnet pass suitably through the movable iron core.

That is, the magnetic flux that interlinks with the stator on the outer side of the rotor in the radial direction (i.e., the field magnetic flux due to the magnet of the rotor) is satisfactorily suppressed so as to be small. Accordingly, by changing the characteristics of the rotating electric machine while reducing the torque or the induced voltage, the number of revolutions of the rotor can be suitably increased.

(3) In the above aspect (1) or (2), the rotor core may have a hole portion through which the movable iron core is insertable on a d-axis.

According to the above aspect (3), the movable iron core can be disposed on the d-axis in a state in which the movable iron core is inserted through the hole portion of the rotor core. Therefore, the movable iron core can be disposed at the center of the rotor poles in the circumferential direction of the rotor. This makes it possible to make magnetic fluxes generated on both sides of the d-axis uniform, at the poles of the rotor. As a result, in particular, rotation of the rotor can be suitably maintained during high-speed rotation of the rotor.

(4) In the above aspect (3), the hole portion may be formed over the entire region of the stacked thickness of the rotor core.

According to the above aspect (4), by forming the hole portion over the entire region of the stacked thickness of the rotor core, it is possible to dispose the movable iron core over the entire region of the stacked thickness of the rotor core. A magnetic path can be formed over the entire region of the stacked thickness of the rotor core with the movable iron core being disposed as such. Therefore, the magnetic flux generated from the magnet of the rotor can be made to pass through the movable iron core, and the magnetic flux interlinking with the stator on the outer side of the rotor in the radial direction (i.e., the field magnetic flux due to the magnet of the rotor) can be suppressed so as to be small. Accordingly, by changing the characteristics of the rotating electric machine while suppressing the torque or the induced voltage, the number of revolutions of the rotor can be suitably increased.

(5) In any one of the above aspects (1) to (4), the variable field magnet rotating electric machine may further include an actuator configured to move the movable iron core in the axial direction of the rotary shaft, and the actuator may be configured to operate with hydraulic fluid supplied via the interior of the rotary shaft.

According to the above aspect (5), the actuator is configured such that the hydraulic fluid is supplied via the interior of the rotary shaft. Therefore, a flow path for supplying the hydraulic fluid can be formed inside the rotary shaft. Therefore, the number of parts of the actuator can be reduced, and the rotor (i.e., the rotating electric machine) can be simplified.

According to the aspects of the present invention, the movable iron core extends in the axial direction of the rotary shaft, and the movable iron core can be movably inserted into the rotor core. Accordingly, the number of revolutions of the rotor can be suitably increased, and the present invention can also be applied to increase in size of the variable field magnet rotating electric machine.

### BRIEF DESCRIPTION OF THE DRAWINGS

FIG. 1 is a cross-sectional view illustrating a schematic configuration of a variable field magnet rotating electric machine according to an embodiment of the present invention.

FIG. 2 is a cross-sectional view illustrating a state in which the rotor rotates at high speed in the variable field magnet rotating electric machine according to the embodiment of the present invention.

FIG. 3 is a cross-sectional view taken along the line of FIG. 2 illustrating the variable field magnet rotating electric machine according to the embodiment of the present invention.

FIG. 4 is a cross-sectional view illustrating a state in which the rotor rotates at a low speed in the variable field magnet rotating electric machine according to the embodiment of the present invention.

FIG. 5 is a cross-sectional view taken along the line V-V of FIG. 4 illustrating the variable field magnet rotating electric machine according to the embodiment of the present invention.

FIG. 6 is a graph illustrating a relationship between a torque and number of revolutions of the variable field magnet rotating electric machine according to the embodiment of the present invention.

### DETAILED DESCRIPTION OF THE INVENTION

Embodiments of the present invention will be described below with reference to the drawings. In each drawing used for the following description, the scales of respective members may have been appropriately changed. Further in the following description, components having the same or similar functions are denoted by the same reference numerals. Further, in some cases, repeated explanation of those configurations may be omitted. Further, in the following description, a variable field magnet rotating electric machine 1 is abbreviated as a “rotating electric machine 1”.

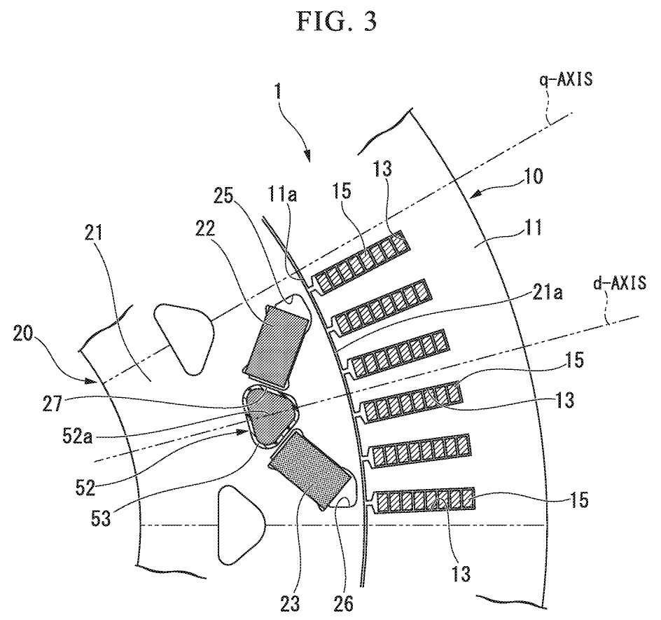

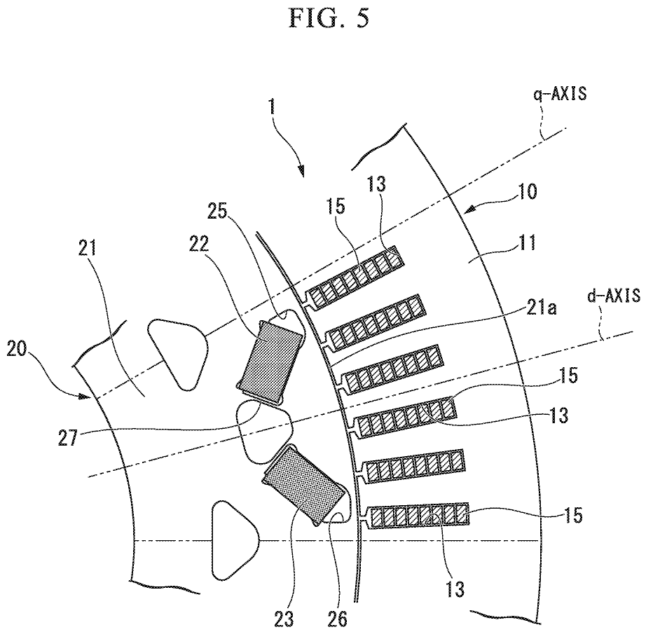

In FIGS. 3 and 5, in order to facilitate understanding of the configuration of the rotating electric machine 1, a description for a break line will be omitted.

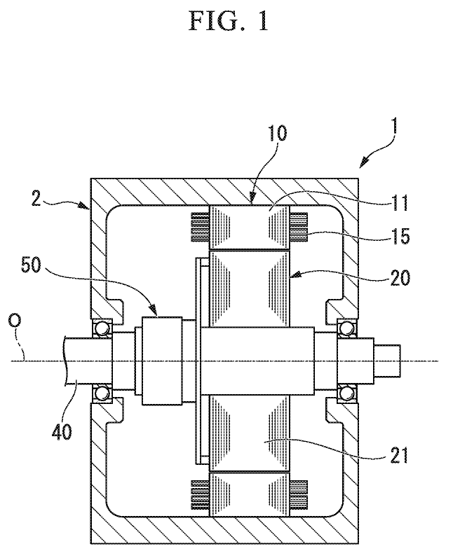

FIG. 1 is a cross-sectional view illustrating a schematic configuration of a rotating electric machine 1 of an embodiment.

As illustrated in FIG. 1, the rotating electric machine 1 is, for example, a running motor mounted on a vehicle such as a hybrid vehicle or an electric vehicle. As illustrated in FIG. 1, the rotating electric machine 1 includes a housing 2, a stator 10, a rotor 20, a shaft (rotary shaft) 40, and a variable field mechanism 50.

The housing 2 accommodates the stator 10, the rotor 20, and the variable field mechanism 50, and rotatably supports the shaft 40. Further, the stator 10, the rotor 20 and the shaft 40 are each disposed with an axis O (predetermined axis) as a common axis. Hereinafter, the direction in which the axis O extends will be referred to as the axial direction, a direction orthogonal to the axis O will be referred to as the radial direction, and a direction circling around the axis O will be referred to as a circumferential direction.

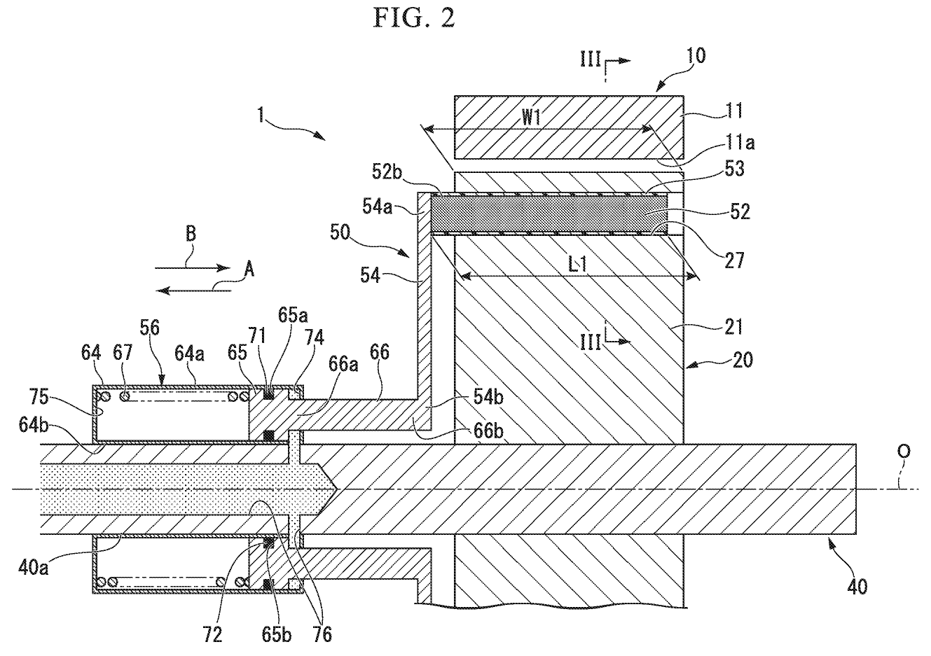

FIG. 2 is a cross-sectional view illustrating a state in which the rotor 20 rotates at a high speed in the rotating electric machine 1 in an embodiment. FIG. 3 is a cross-sectional view taken along the line of FIG. 2 illustrating the rotating electric machine 1 in an embodiment.

As illustrated in FIGS. 2 and 3, the stator 10 includes a stator core 11, and coils 15 of a plurality of layers (for example, a U-phase, a V-phase, a W-phase) mounted on the stator core 11. The stator 10 generates a magnetic field when a current flows through the coil 15. The stator core 11 is formed in a cylindrical shape extending in a direction of the axis O (an axial direction). The stator core 11 is formed by, for example, laminating a plurality of electromagnetic steel plates (silicon steel plates) in the axial direction. Further, the stator core 11 may be formed by press-molding a soft magnetic powder.

In the stator core 11, coil slots 13 into which the coils 15 are inserted are provided side by side in the circumferential direction. The coils 15 are segment coils configured by, for example, inserting a plurality of conductor segments formed by a rectangular wire into the coil slots 13 of the stator core 11 and by connecting the conductor segments to each other at a portion protruding in the axial direction from the stator core 11.

The rotor 20 is disposed on the inner side of the stator 10 in the radial direction. The rotor 20 includes a rotor core 21, a plurality of first permanent magnets (magnets) 22, and a plurality of second permanent magnets (magnets) 23. The rotor core 21 is formed in a cylindrical shape that uniformly extends in the axial direction and is disposed to face an inner circumferential surface 11a of the stator core 11. The rotor core 21 is formed, for example, by laminating a plurality of electromagnetic steel plates (silicon steel plates) in the axial direction. In addition, the rotor core 21 may be formed by press-molding a soft magnetic powder.

The shaft 40 is inserted into the rotor core 21, and is coaxially provided by press-fitting or the like. As a result, the rotor core 21 is provided to be rotatable around the axis O integrally with the shaft 40.

In the rotor core 21, a first accommodation slot 25, a second storage slot 26, and a third storage slot 27 are formed, for example, in each of circumferential angle regions of 1/12 around a circumference. The third storage slot 27 is formed between the first storage slot 25 and the second storage slot 26 in the circumferential direction and is disposed along an outer circumferential wall 21a of the rotor core 21.

The third storage slot 27 is formed, for example, to have a trapezoidal cross section when viewed from the direction of the axis O. The third storage slot 27 is a hole portion through which a movable iron core 52 (to be described later) can be inserted on a d-axis. The third storage slot 27 is formed over an entire region W1 of the stacked thickness of the rotor core 21.

The first storage slot 25 is formed in an inclined shape in a direction away from the third storage slot 27 from one end portion of the third storage slot 27 toward the outer circumferential wall 21a of the rotor core 21 when viewed from the direction of the axis O. The second storage slot 26 is formed in an inclined shape in a direction away from the third storage slot 27 from the other end portion of the third storage slot 27 toward the outer circumferential wall 21a of the rotor core 21 when viewed from the direction of the axis O.

The first storage slot 25, the second storage slot 26, and the third storage slot 27 are disposed, for example, in a curved shape (or V-shaped) in a direction away from the outer circumferential wall 21a of the rotor core 21 when viewed from the direction of the axis O.

Here, in the rotor core 21, the first permanent magnet 22 is accommodated in the first storage slot 25 to extend in the direction of the axis O. The first permanent magnet 22 is formed, for example, in a rectangular cross section in the radial direction. When epoxy resin (thermosetting resin) is filled, for example, into a gap between the first storage slot 25 and the first permanent magnet 22, the first permanent magnet 22 is held in the first storage slot 25 in a stored state. Therefore, the first permanent magnet 22 is formed over the entire region W1 of the stacked thickness of the rotor core 21.

Further, the second permanent magnet 23 is stored in the second storage slot 26. The second permanent magnet 23 is formed, for example, in a rectangular cross section in the radial direction. When epoxy resin (thermosetting resin) is filled, for example, into the gap between the second storage slot 26 and the second permanent magnet 23, the second permanent magnet 23 is held in the second storage slot 26 in a stored state. As a result, the second permanent magnet 23 is formed over the entire region W1 of the stacked thickness of the rotor core 21.

Therefore, in the first storage slot 25 and the second storage slot 26 of the rotor core 21, the first permanent magnet 22 and the second permanent magnet 23 are provided as poles. That is, the rotor 20 constitutes an IPM type rotor in which the first permanent magnet 22 and the second permanent magnet 23 are embedded in the rotor core 21.

Further, a movable iron core 52 (to be described later) is stored in the third storage slot 27. In the cross-section in the radial direction, a central portion 52a of the movable iron core 52 is disposed on the d-axis of the rotating electric machine 1. The central portion 52a is a part extending in the radial direction of the rotor core 21. Therefore, the movable iron core 52 is disposed at the center of the pole of the rotor 20 in the circumferential direction of the rotor 20. The reason why the movable iron core 52 is disposed at the center of the pole of the rotor 20 will be described in detail later.

The variable field mechanism 50 includes a plurality of movable iron cores 52, a connecting member 54, and a movable mechanism (actuator) 56.

The movable iron core 52 is formed, for example, in a trapezoidal cross section when viewed from the direction of the axis O and extends so as to be movable in the direction of the axis O. Specifically, the movable iron core 52 is formed so as to be insertable in the direction of the axis O with respect to the third storage slot 27. The movable iron core 52 is formed to have a movable iron core length dimension L1 slightly longer than the stacked thickness W1 of the rotor core 21. Therefore, the movable iron core 52 can be disposed over the entire region of the stacked thickness W1 of the rotor core 21.

Further, the movable iron core length dimension L1 of the movable iron core 52 may be a length equal to the stacked thickness W1 of the rotor core 21. By making the movable iron core length dimension L1 equal to the stacked thickness W1 of the rotor core 21, it is possible to reduce unnecessary loss due to the movable iron core 52, as compared with a case in which the movable iron core length dimension L1 is formed to be longer than the stacked thickness W1 of the rotor core 21.

In this case, a portion of the nonmagnetic connecting member 54, which faces the movable iron core 52, is made to protrude toward the movable iron core 52, and the movable iron core 52 is connected to the protruding portion. Accordingly, in a state in which the movable iron core 52 is sufficiently stored in the third storage slot 27, it is possible to suitably secure the distance between the connecting member 54 and the rotor core 21.

As a material of the movable iron core 52, a material in which a magnetic path is formed in a state in which the movable iron core 52 is stored in the third storage slot 27 is adopted. Specifically, as the material of the movable iron core 52, it is preferable to use, for example, silicon steel (also referred to as silicon iron) which is the same material as the rotor core 21 or the stator 10.

Therefore, by disposing the movable iron core 52 over the entire region of the stacked thickness W1 of the rotor core 21, it is possible to form a magnetic path over the entire region of the stacked thickness W1 of the rotor core 21 with the movable iron core 52.

As a result, the magnetic flux generated from the first permanent magnet 22 and the second permanent magnet 23 of the rotor 20 can be made to pass through the movable iron core 52. Therefore, the magnetic flux interlinking with the stator 10 on the outer side of the rotor 20 in the radial direction (i.e., the field magnetic flux due to the first permanent magnet 22 and the second permanent magnet 23) is suppressed so as to be small. As a result, by suppressing the torque or the induced voltage of the rotating electric machine 1 to change the characteristics of the rotating electric machine 1, the number of revolutions of the rotor 20 can be increased.

In addition, the first permanent magnet 22 and the second permanent magnet 23 are embedded in the rotor core 21 as poles. Therefore, the movable iron core 52 can be disposed in the vicinity of the first permanent magnet 22 and the second permanent magnet 23. As a result, the magnetic flux generated from the first permanent magnet 22 and the second permanent magnet 23 can be made to suitably pass through the movable iron core 52.

Therefore, the magnetic flux interlinking with the stator 10 (i.e., the field magnetic flux due to the first permanent magnet 22 and the second permanent magnet 23 of the rotor 20) is satisfactorily suppressed. As a result, by suppressing the torque or the induced voltage of the rotating electric machine 1 to change the characteristics of the rotating electric machine 1, it is possible to appropriately increase the number of revolutions of the rotor 20.

Furthermore, since the movable iron core 52 is stored in the third storage slot 27, the central portion 52a of the movable iron core 52 is disposed on the d-axis of the rotating electric machine 1. Therefore, the movable iron core 52 is disposed at the center of the pole of the rotor 20 in the circumferential direction of the rotor 20. As a result, magnetic fluxes generated on both sides of the d-axis can be made uniform at the poles of the rotor 20. As a result, the rotation of the rotor 20 can be suitably maintained particularly during high speed rotation of the rotor 20.

Here, for example, the movable iron core 52 is integrally molded so that a coating layer 53 is coated on the entire circumferential surface. The coating layer 53 is formed of a resin material having sufficient sliding characteristics (low friction coefficient, abrasion resistance, and self lubricity). Examples of a resin having preferable sliding characteristics include, for example, polyimide resin (PI), polyacetal resin (POM), polytetrafluoroethylene/tetrafluoroethylene resin (PTFE), polyphenylene sulfide (PPS) and the like.

Further, by adding carbon as a filler to a resin material such as PI, POM, PTFE, and PPS, the frictional force can be lowered further. Therefore, when the movable iron core 52 moves while being inserted through the third storage slot 27, the frictional force of the movable iron core 52 with respect to the surface of the third storage slot 27 can be suppressed so as to be small.

Here, the coating layer 53 is coated so that the magnetic flux generated from the first permanent magnet 22 and the second permanent magnet 23 can suitably pass through the movable iron core 52. Further, for example, a magnetic powder or the like may be contained in the coating layer 53.

Further, in a state in which the movable iron core 52 is movably inserted into the third storage slot 27, a proximal end portion 52b of the movable iron core 52 communicates with the connecting member 54. The connecting member 54 is formed, for example, in the shape of a disk, and a plurality of movable iron cores 52 are connected at an outer circumferential portion 54a at intervals in the circumferential direction. In a state in which the plurality of movable iron cores 52 are connected to the connecting member 54, the movable iron core 52 extends in the direction of the axis O to be insertable into the third storage slot 27.

The connecting member 54 is connected to the movable mechanism 56.

The movable mechanism 56 is configured to be capable of moving the movable iron core 52 in the axial direction (direction of the axis O) of the shaft 40. Specifically, the movable mechanism 56 includes a cylinder portion 64, a piston 65, a piston rod 66, and a return spring 67.

The cylinder portion 64 is annularly formed along the circumferential wall 40a of the shaft 40 in a state of being supported by the circumferential wall 40a of the shaft 40. The piston 65 is stored in the cylinder portion 64 to be freely slidable in the direction of the axis O. The piston 65 is formed in an annular shape, and has an annular outer circumferential groove 65a and an annular inner circumferential groove 65b.

An outer circumferential seal 71 is fitted to the outer circumferential groove 65a of the piston 65. The outer circumferential seal 71 is in contact with the cylinder outer circumferential wall 64a inside the cylinder portion 64. An inner circumferential seal 72 is fitted to the inner circumferential groove 65b of the piston 65. The inner circumferential seal 72 is in contact with the cylinder inner circumferential wall 64b inside the cylinder portion 64.

The interior of the cylinder portion 64 is partitioned by the piston 65 into a first cylinder chamber 74 and a second cylinder chamber 75. The first cylinder chamber 74 communicates with an oil supply passage 76. The oil supply passage 76 is formed inside the shaft 40. Therefore, the oil supply passage 76 can be formed using the shaft 40. As a result, the number of parts of the movable mechanism 56 can be reduced, and the rotor 20 (i.e., the rotating electric machine 1) can be simplified.

On the other hand, for example, the return spring 67 is stored in the second cylinder chamber 75. According to the movable mechanism 56, hydraulic oil (hydraulic fluid) is supplied to the first cylinder chamber 74 via the inside of the shaft 40 (i.e., the oil supply passage 76). Due to the hydraulic oil supplied to the first cylinder chamber 74, the piston 65 operates in the direction of the axis O as indicated by an arrow A.

Further, a piston rod 66 is integrally attached to the piston 65. The proximal end portion 66a of the piston rod 66 is integrally attached to the piston 65. The piston rod 66 is annularly formed along the circumferential wall 40a of the shaft 40 with an interval between it and the circumferential wall 40a of the shaft 40. A distal end portion 66b of the piston rod 66 is connected to the central portion 54b of the connecting member 54.

The rotating electric machine 1 of the embodiment is configured such that, when the rotor 20 rotates at a low speed, the hydraulic oil is supplied to the first cylinder chamber 74 from the oil supply passage 76. By supplying the hydraulic oil to the first cylinder chamber 74, the piston 65 moves against the spring force of the return spring 67 in the direction of the axis O as indicated by an arrow A. As the piston 65 moves, the movable iron core 52 moves in the direction of the axis O as indicated by the arrow A via the piston rod 66 and the connecting member 54.

On the other hand, when the rotor 20 rotates at a high speed, the hydraulic oil in the first cylinder chamber 74 is discharged from the first cylinder chamber 74 via a drain circuit (not illustrated). By discharging the hydraulic oil from the first cylinder chamber 74, the piston 65 is moved in the direction of the axis O as indicated by an arrow B by the spring force of the return spring 67. As the piston 65 moves, the movable iron core 52 moves in the direction of the axis O as indicated by the arrow B via the piston rod 66 and the connecting member 54.

Since the movable iron core 52 moves as indicated by the arrow B, the movable iron core 52 is disposed over the entire region of the stacked thickness W1 of the rotor core 21. As a result, a path through which the magnetic flux passes is formed over the entire region of the stacked thickness W1 of the rotor core 21.

Further, the movable iron core 52 extends in the direction of the axis O of the shaft 40. Therefore, it is not necessary to directly attach the movable iron core 52 to the shaft 40. Thus, it is possible to connect the entire region of the stacked thickness W1 of the rotor core 21 to the shaft 40. That is, a large region of the rotor core 21 which connects to the shaft 40 can be ensured.

Therefore, even when the size of the rotor core 21 (i.e., the rotor 20) increases, it is possible to secure the strength of the connecting region which connects the rotor core 21 to the shaft 40, and the present invention can be applied to an increase in size of the rotating electric machine 1. As a result, it is possible to adopt the same structure regardless of whether there is a small or large rotor in the rotating electric machine 1.

Next, a relationship between the torque (load) of the rotating electric machine 1 and the number of revolutions of the rotor 20 will be described with reference to FIGS. 2 to 6.

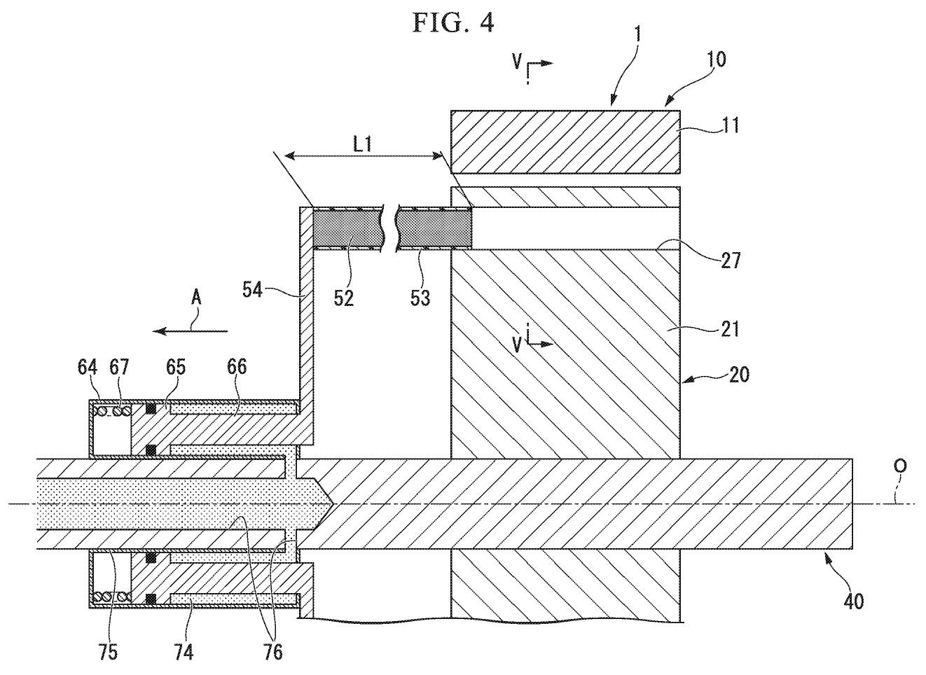

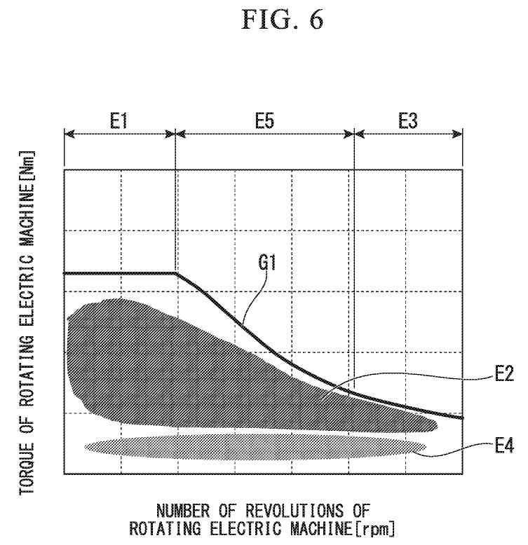

FIG. 4 is a cross-sectional view illustrating a state in which the rotor 20 rotates at a low speed in the rotating electric machine 1 in an embodiment. FIG. 5 is a cross-sectional view taken along the line V-V of FIG. 4 illustrating the rotating electric machine 1 in an embodiment. FIG. 6 is a graph illustrating a relationship between a torque and number of revolutions of the rotating electric machine 1 in an embodiment. In FIG. 6, an ordinate represents the torque [N m] of the rotating electric machine 1, and an abscissa represents the number of revolutions [rpm] of the rotating electric machine 1 (i.e., the rotor 20). A graph G1 is a graph illustrating a relationship between the torque of the rotating electric machine 1 and the number of revolutions.

First, the relationship between the torque of the rotating electric machine 1 and the number of revolutions of the rotor 20 when the rotor 20 of the rotating electric machine 1 rotates at a low speed will be described with reference to FIGS. 4 to 6.

As illustrated in FIGS. 4 and 5, when the rotor 20 rotates at a low speed, the hydraulic oil is supplied to the first cylinder chamber 74 from the oil supply passage 76. Therefore, the piston 65 is held at the end portion side of the second cylinder chamber 75 against the spring force of the return spring 67. As a result, the movable iron core 52 moves from the rotor core 21 in the direction shown by the arrow A and is kept in a state of being extracted from the third storage slot 27 (i.e. a removed state).

Therefore, the third storage slot 27 remains empty such that the space serves as a flux barrier. The third storage slot 27 serves as the flux barrier so that the magnetic flux generated from the first permanent magnet 22 and the second permanent magnet 23 of the rotor 20 can be prevented from passing through the space. That is, it is possible to prevent formation of a magnetic path through which the magnetic flux generated from the first permanent magnet 22 and the second permanent magnet 23 passes.

This makes it possible to secure a large magnetic flux interlinking with the stator 10 on the outer side of the rotor 20 in the radial direction (i.e., the field magnetic flux due to the first permanent magnet 22 and the second permanent magnet 23 of the rotor 20).

As a result, the torque density of the rotating electric machine 1 increases and the induced voltage increases.

As illustrated in FIGS. 4 and 6, when the rotor core 20 is controlled so that the movable iron core 52 is removed from the rotor core 21 in a region E1 of the low-speed rotation (hereinafter referred to as a low-speed rotation region E1), the high torque region (a high load region) E2 can be secured. That is, in the high torque region, by controlling the movable iron core 52 such that it is removed from the rotor core 21, it is possible to efficiently drive the rotating electric machine 1 during low speed rotation.

Next, the relationship between the torque of the rotating electric machine 1 and the number of revolutions of the rotor 20 when the rotor 20 of the rotating electric machine 1 rotates at a high speed will be described with reference to FIGS. 2, 3, and 6.

As illustrated in FIGS. 2 and 3, when the rotor 20 rotates at a high speed, the hydraulic oil in the first cylinder chamber 74 is discharged from the first cylinder chamber 74 via the drain circuit. Therefore, the piston 65 is moved in the direction of the arrow B by the spring force of the return spring 67 and is held on the end portion side of the first cylinder chamber 74. As a result, the movable iron core 52 is stored in the entire region of the third storage slot 27.

Therefore, the movable iron core 52 is disposed over the entire region of the stacked thickness W1 of the rotor core 21. As a result, a magnetic path is formed by the movable iron core 52 over the entire region of the stacked thickness W1 of the rotor core 21. Therefore, the magnetic flux generated from the first permanent magnet 22 and the second permanent magnet 23 of the rotor 20 passes through the movable iron core 52, and the magnetic flux interlinking with the stator 10 is suppressed so as to be small. As a result, the torque or the induced voltage of the rotating electric machine 1 can be suppressed so as to be low thereby increasing the number of revolutions of the rotor 20.

As illustrated in FIGS. 2 and 6, the rotor 20 is controlled so that the movable iron core 52 is disposed over the entire region of the stacked thickness W1 of the rotor core 21 in a region E3 of high-speed rotation (hereinafter referred to as a high-speed rotation region E3). Therefore, a low torque region (low load region) E4 can be secured. That is, by controlling the movable iron core 52 such that it is disposed on the rotor core 21 in the low torque region E4, it is possible to efficiently drive the rotating electric machine 1 during high-speed rotation.

As described above, the rotating electric machine 1 performs control so that the movable iron core 52 is disposed in the rotor core 21 (i.e., the third storage slot 27) in the low torque region. Further, the rotating electric machine 1 performs control to remove the movable iron core 52 from the rotor core 21 (i.e., the third storage slot 27) in the high torque region.

In this way, by controlling the amount of movement of the movable iron core 52 depending on the load acting on the rotating electric machine 1, it is possible to efficiently drive the rotating electric machine 1 in the low torque region or the high torque region.

Here, as illustrated in FIG. 6, the rotating electric machine 1 is configured to perform control so that the movable iron core 52 is gradually stored in the third storage slot 27 in a region E5 from the low-speed rotation region E1 to the high-speed rotation region E3. Therefore, when moving from the low-speed rotation region E1 to the high-speed rotation region E3 of the rotating electric machine 1, the rotating electric machine 1 can be efficiently driven in the region E5 by suitably changing the torque and the number of revolutions of the rotating electric machine 1.

Further, the technical scope of the present invention is not limited to the above-described embodiments, and various modifications can be made within the scope that does not depart from the gist of the present invention.

For example, in the above-described embodiment, an example in which the rotor 20 is configured as an IPM type has been described, but the present invention is not limited thereto. As another example, the rotor 20 can also be configured as a surface permanent magnet motor (SPM) type. By configuring the rotor 20 as an SPM type, it is possible to efficiently utilize a magnet with strong magnetism.

Further, in the above embodiment, an example in which the resin coating layer 53 is coated on the entire circumferential surface of the movable iron core 52 has been described, but the present invention is not limited thereto. As another example, it is also possible to provide, for example, a configuration in which the coating layer 53 is not coated on the entire circumferential surface of the movable iron core 52.

Further, although an example in which the coating layer 53 is coated on the movable iron core 52 has been described, as another example, for example, it is also possible to coat the circumferential surface of the third storage slot 27 with a coating layer.

Further, in the aforementioned embodiment, although an example in which the return spring 67 is provided in the second cylinder chamber 75, and the piston 65 (i.e., the piston rod 66) is returned to the rotor core 21 side by the spring force of the return spring 67 has been described, the present invention is not limited thereto. As another example, it is also possible to return the piston rod 66 to the rotor core 21 side, for example, by supplying hydraulic oil to the second cylinder chamber 75 instead of the return spring 67.

Furthermore, in the above embodiment, an example in which a hydraulic cylinder is used as the movable mechanism 56 has been described, but the present invention is not limited thereto. As another example, it is also possible to use, for example, an air type cylinder.

Further, the movable mechanism 56 is not limited to a cylinder, and other movable mechanisms can also be used.

What is claimed is:

1. A variable field magnet rotating electric machine comprising:
a stator;
a rotor in which a rotary shaft is provided on a rotor core; and
a movable iron core extending in an axial direction of the rotary shaft,
wherein the movable iron core is configured to be capable of being inserted into the rotor core and to be movable in the axial direction.

2. The variable field magnet rotating electric machine according to claim 1, wherein the rotor is an IPM in which a magnet is embedded in the rotor core.

3. The variable field magnet rotating electric machine according to claim 1, wherein the rotor core has a hole portion through which the movable iron core is insertable on a d-axis.

4. The variable field magnet rotating electric machine according to claim 3, wherein the hole portion is formed over an entire region of a stacked thickness of the rotor core.

5. The variable field magnet rotating electric machine according to claim 1, further comprising:
an actuator configured to move the movable iron core in the axial direction of the rotary shaft,
wherein the actuator is configured to operate with hydraulic fluid supplied via the interior of the rotary shaft.
